(19) United States
(12) Patent Application Publication
(10) Pub. No.: US 2025/0077626 A1
(43) Pub. Date: Mar. 6, 2025

(54) System and Method for Two-Way Projection of Information between a User and an Entity and Contactless Communication of a Data Item

(71) Applicant: Bank of America Corporation, Charlotte, NC (US)

(72) Inventors: Yingcai Peng, Celina, TX (US); Maneesh Kumar Sethia, Hyderabad (IN); Abhijit Behera, Hyderabad (IN); Ankit Kumar Sahoo, Hyderabad (IN)

(21) Appl. No.: 18/461,585

(22) Filed: Sep. 6, 2023

(51) Int. Cl. G06F 21/10; G06F 21/31

(52) U.S. Cl. CPC G06F 21/1014; G06F 21/1015; G06F 21/31

(57) ABSTRACT

A system for two-way projection of information and contactless communication of a data item includes a memory and a processor coupled to the memory. The processor initiates a virtual session for an interaction between an entity owner and a user relating to a set of objects and generates a non-fungible token for the virtual session. The processor tracks current information associated with the set of objects and simultaneously project the current information to a first virtual device of the entity owner and a second virtual device of the user. The processor receives, via the second virtual device of the user, a selection of one or more objects and a data item with respect to the selected objects. The processor communicates the data item and the generated non-fungible token for fulfillment of the selected objects to the user. The data item is communicated without requiring explicit contact by the user.

### TECHNICAL FIELD

The present disclosure relates generally to user interactions, and more specifically to two-way projection of information between a user and an entity, and contactless communication of a data item.

### BACKGROUND

Nowadays, users are generally more inclined to interact with entities in an online environment. Performing an interaction between an entity and a user in the online environment is susceptible to various types of online attacks. Furthermore, information associated with one or more data objects that are presented to the user and the entity may not be up to date. Due to this, the user and/or the entity may end up viewing stale information, which wastes valuable networking and computing resources.

### SUMMARY

The system and method implemented by the system as disclosed in the present disclosure provide technical solutions to the technical problems discussed above by projecting current or real-time information associated with a set of objects to both an entity owner associated with an entity and a user. The current information associated with the set of objects that is projected to the entity owner and the user may be simultaneously projected using mesh technology to virtual devices associated with the entity owner and the user. For example, the current information associated with the set of objects may be projected to a first virtual device associated with the entity owner and to a second virtual device associated with the user. In one embodiment, the current information associated with the set of objects that is projected to the first virtual device of the entity owner may include a count information indicating a total number of objects currently available for each type of the set of objects. In one embodiment, the current information associated with the set of objects that is projected to the second virtual device of the user may include a three-dimensional (3D) view (e.g., a 360-degree view) of each object of the set of objects.

Based on the information that is projected to the second virtual device of the user, the user may select one or more objects from the set of objects and provide a particular mode of communication of the data item with respect to the selected objects using one or more of different contactless input mechanisms associated with the second virtual device of the user. For example, the user may provide the data item for the selected objects using an eye gesture (e.g., blinking their eyes), a voice command, or some sort of haptic feedback. This way, the user may perform an interaction with the entity owner in a virtual environment with respect to the one or objects of the set of objects without requiring an explicit contact by the user. The interaction discussed herein is performed by initiating a virtual session, where the entity owner and the user interact with each other during the virtual session using their virtual devices. A non-fungible token is generated that is unique to this virtual session. Since the non-fungible token exists only for the virtual session and is no longer available after this session, information associated with the virtual session, such as, for example and without limitation, user information and entity owner information, remain confidential and are secured from various types of attacks present in a virtual or an online environment.

In one embodiment, the disclosed system for two-way projection of information and contactless communication of a data item includes a memory and a processor that is operably coupled to the memory. The memory may store a set of objects, user information associated with a user, and entity information associated with an entity owner. The processor is configured to determine the entity owner associated with a first virtual device and the user associated with a second virtual device. The first virtual device or the second virtual device may be a wearable artificial reality device. In one embodiment, determining the entity owner associated with the first virtual device and the user associated with the second virtual device may include requesting the entity owner for the entity information to authenticate the entity owner, requesting the user for the user information to authenticate the user, and authenticating the entity owner and the user based on the entity information and the user information, respectively. After authenticating the entity owner and the user, the processor is configured to initiate a virtual session for an interaction between the entity owner and the user relating to one or more objects of the set of objects. The entity owner and the user may interact with each other during the virtual session using their virtual devices.

Once the virtual session is initiated between the entity owner and the user, the processor is configured to generate a non-fungible token for the virtual session. The generated non-fungible token is unique to the virtual session and may include the user information associated with the user, the entity information associated with the entity owner, session information associated with the virtual session, and unique identifiers associated with the first and second virtual devices. The processor is then configured to track, in real time, current information associated with the set of objects using a plurality of trackers, where each tracker may be configured to track a subset of objects of a particular type.

Responsive to tracking the current or real-time information associated with the set of objects using the plurality of trackers, the processor is configured to project (1) the current information associated with the set of objects to the first virtual device of the entity owner and (2) the current information associated with the set of objects to the second virtual device of the user. The current information associated with the set of objects that is projected to the first virtual device of the entity owner may be configured to be used by the entity owner to monitor and update records associated with the set of objects. The current information associated with the set of objects that is projected to the second virtual device of the user may be configured to be used by the user to navigate and select the one or objects from the set of objects. In some embodiments, the processor is further configured to receive insight data representing historical preferences and interactions of a set of users including the user with respect to the set of objects and suggest a subset of objects from the set of objects or additional objects relating to the set of objects for display on the second virtual device of the user based on the insight data.

From the projected information to the user, the processor is configured to receive, via the second virtual device of the user, a selection of the one or more objects from the set of objects. In some embodiments, responsive to receiving the selection of the one or more objects from the set of objects, the processor is further configured to update, in real time, information associated with the set of objects using the plurality of trackers (e.g., remove the selected one or more objects from the set of objects stored in the memory) and project updated information associated with the set of objects to one or more of the first virtual device of the entity owner or the second virtual device of the user. The updated information may be used by the entity owner to update the records associated with the set of objects, and the updated information may be used by the user to navigate and select a subsequent set of objects. Based on the user selection of the one or more objects from the set of objects, the processor is configured to request the user to communicate a data item with respect to the selected one or more objects and in response receive, via the second virtual device of the user, a particular mode of communication of the data item with respect to the selected one or more objects using one or more of different contactless input mechanisms associated with the second virtual device of the user. The different contactless input mechanisms may include, for example and without limitation, an eye gesture, a voice command, or haptic feedback.

Responsive to receiving the data item for the selected one or more objects, the processor is configured to communicate (1) the data item for the selected one or more objects using the particular mode of communication of the data item and (2) the generated non-fungible token for fulfillment of the selected one or more objects to the user. The data item is communicated for the selected one or more objects without requiring explicit contact by the user. The processor is then configured to process, using the generated non-fungible token, the data item so as to fulfill the selected one or more objects to the user. After processing of the data item, the processor is configured to generate a confirmation of successful processing of the data item and fulfillment of the selected one or more objects. The confirmation may be sent to one or more of the first virtual device of the entity owner, the second virtual device of the user, or the plurality of trackers. In some embodiments, responsive to the fulfillment of the selected one or more objects, the processor is further configured to update information associated with the set of objects using the plurality of trackers. The updated information may be sent to the first virtual device of the entity owner to update the records associated with the set of objects.

The disclosed system and method provide several practical applications and technical advantages. For example, the disclosed system and method enable simultaneous two-way projection of current or real-time information associated with the set of objects. The information that is projected on the first virtual device of the entity owner may be used by the entity owner to monitor and update records associated with the set of objects. The information that is projected on the second virtual device of the user may be used by the user to navigate and select one or more objects from the set of objects. The simultaneous two-way projection of the current or real-time information may help the entity owner associated with the entity to keep their records associated with the objects up to date. In addition, the two-way projection of real-time information may help the entity owner to see what particular objects the user is interacting with and may further enable the entity owner to reach out to the user as needed to help drive their object selection. Since the same information is projected to both the entity owner as well as the user by way of the two-way projection discussed herein, the disclosed system and method save the time and resources (e.g., processing resources, memory resources, network bandwidth etc.) which would otherwise be expended when projecting different information to different users and/or entities. Furthermore, the simultaneous two-way projection of real-time information ensures that the entity owner and the user are always viewing current available objects and associated information. This enables the entity owner to keep an accurate count of the objects and the user to not select objects that are not available (e.g., because these objects have been previously selected by another user). Once the user selects one or more objects, the information associated with the set of objects may be updated in real-time to reflect the current information. For example, the selected objects may be removed from the set of objects.

The disclosed system and method further enable contactless communication of a data item for one or objects selected from the set of objects. For instance, based on the user selection of the one or more objects, a contactless communication of data item process may be initiated to fulfill the selected objects to the user. As an example, the data item for the selected objects may be communicated to a server for processing simply by an eye gesture (e.g., user blinking their eyes), a voice command, or some sort of haptic feedback. This way the user may perform an interaction with the entity owner in a virtual environment without requiring an explicit contact by the user. The interaction discussed herein is performed by initiating a virtual session, where the entity owner and the user interact with each other during the virtual session using their virtual devices. A non-fungible token is generated that is unique to this virtual session. Since the non-fungible token exists only for the virtual session and is no longer available after this session, information associated with the virtual session, such as, for example and without limitation, user information and entity owner information, remain confidential and are secured from various types of attacks. Thus, the disclosed system and method improve overall data security in a virtual or an online environment. Also, resources (e.g., processing resources, memory resources, network bandwidth etc.) are saved with the use of non-fungible token because information associated with a session only exists for that session and there is no need for saving the information for future use. Furthermore, since the non-fungible token already includes relevant information needed for authenticating the user and the entity owner as well for processing the data item, minimal information is needed from the user and the entity owner at run time and therefore, the disclosed system and method improve the speed of processing the data item and further improve processing efficiency of the processor when authenticating users and processing the data item.

The disclosed system and method provide the additional practical application of saving memory resources. The seamless data flow between real-world systems and virtual-world systems as a result of interoperability of these systems allows each system to store less data by avoiding the same data to be stored in both systems, as data stored in one system can be accessed by the other system. This saves memory resources by avoiding duplication of data. The saving of memory resources may leave more system memory for storing critical data for use in data processing. This provides the additional technical advantage of improving processing efficiency of computing systems that manage the real-world and virtual word environments.

Certain embodiments of the present disclosure may include some, all, or none of these practical applications and technical advantages discussed herein. These practical applications, technical advantages, and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example system, in accordance with one or more embodiments of the present disclosure;

FIG. 2 is an example operational flow of the system of FIG. 1; and

FIGS. 3A-3B illustrate a flowchart of an example method for two-way projection of information and contactless communication of a data item, in accordance with one or more embodiments of the present disclosure.

### DETAILED DESCRIPTION

### Example System

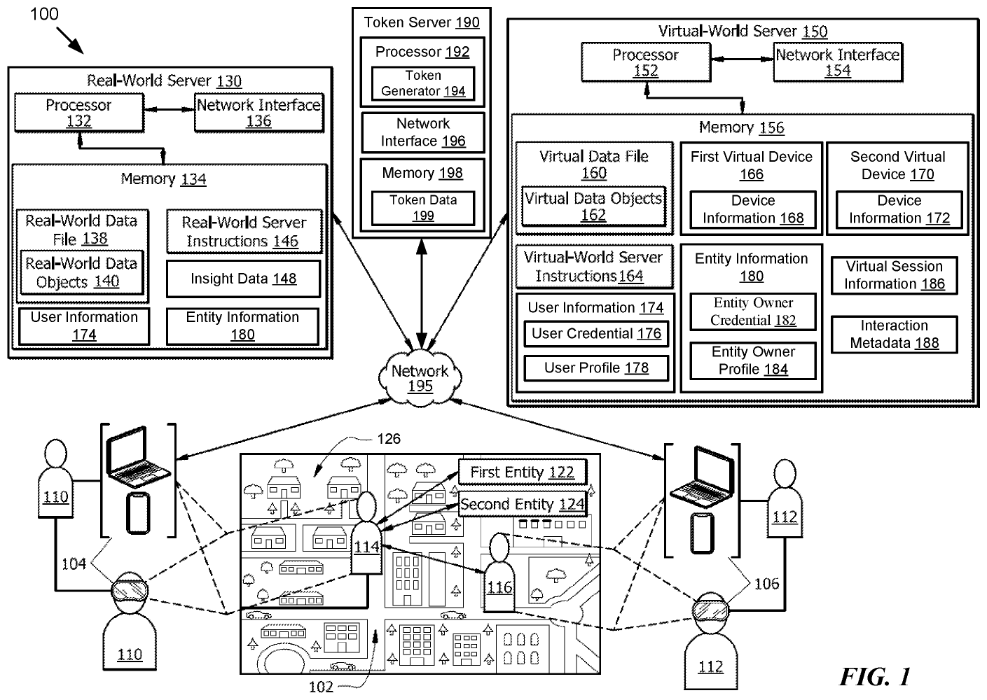

FIG. 1 is a schematic diagram of a system 100, in accordance with certain aspects of the present disclosure. System 100 may include a first user device 104, a second user device 106, a real-world server 130, a virtual-world server 150, and a token server 190, each connected to a network 195. A first user 110 is associated with the first user device 104 and a second user 112 is associated with the second user device 106. In one embodiment, the first user device 104 may be a first virtual device 166 and the second user device 106 may be a second virtual device 170. Each of the first virtual device 166 and the second virtual device 170 may be wearable artificial-reality (AR) devices. The first user 110 associated with the first user device 104 (e.g., first virtual device 166) may be an entity owner associated with an entity, such as, for example, first entity 122 or second entity 124. The second user 112 associated with the second user device 106 (e.g., second virtual device 170) may be a user performing an interaction with the entity owner relating to one or more objects discussed herein. The system 100 may be communicatively coupled to the communication network 195 and may be operable to transmit data between each one of the first user device 104, second user device 106, real-world server 130, virtual-world server 150, and token server 190 through the communication network 195.

In general, the system 100 may improve interoperability of real-world systems and virtual world systems (e.g., metaverse systems) so that information may be seamlessly shared between these systems to implement data security, authorization of data interactions, access to a virtual environment 102 (e.g., metaverse environment), access to entities within the virtual environment 102 and other data interactions performed in real-world and virtual environments. For example, entity information 180 collected from an entity owner (e.g., first user 110) and/or assigned to the entity owner in a real-world environment may be used in the virtual environment 102 (e.g., metaverse environment) to authenticate the first user 110 before allowing the first user 110 to access the virtual environment 102 and perform any kind of action or interaction within the virtual environment 102. Similarly, user information 174 collected from a user (e.g., second user 112) and/or assigned to the user in a real-world environment may be used in the virtual environment 102 (e.g., metaverse environment) to authenticate the second user 112 before allowing the second user 112 to access the virtual environment 102 and perform any kind of action or interaction within the virtual environment 102. Additionally or alternatively, entity information 180 collected from the first user 110 (e.g., entity owner) and the user information 174 collected from the second user 112 in the real-world environment or virtual environment 102 may be used in the virtual environment 102 (e.g., metaverse environment) to provide the first user 110 and the second user 112 access to products, services and/or experiences within the virtual environment 102. This process provides improved information security because it authenticates that a first avatar 114 is associated with the first user 110 and that a second avatar 116 is associated with the second user 112, not an unauthorized party, and that the first user 110 and the second user 112 are authorized to access the virtual environment 102, obtain products, services and experiences within the virtual environment 102 and perform data interactions. Further, a user may obtain a product, service or experience by transferring real-world data objects between real-world entities based on data interactions performed in the virtual environment 102.

It may be noted that the terms “real-world” and “real-world environment” in this disclosure refer to any non-virtual environment where users (e.g., users 110 and 112) can physically interact with real persons and objects. A real-world data interaction may refer to any data interaction performed outside the virtual environment 102 (e.g., a metaverse environment). Further, it may be noted that while certain embodiments of the present disclosure may be described in the context of a metaverse environment which is an example of a virtual environment 102, the methods discussed in this disclosure apply to any other virtual environment 102. The terms “virtual environment” and “metaverse environment” are used interchangeably throughout this disclosure. Furthermore, it may be noted that while certain embodiments of this disclosure describe one or more operations in relation to the first user 110, these embodiments apply to any other user (e.g., second user 112) connected to network 195.

The first user 110 may access the virtual environment 102 (e.g., a metaverse environment) through the first user device 104. Similarly, the second user 112 may access the virtual environment 102 through the second user device 106. Each of the first user device 104 and the second user device 106 is configured to display a two-dimensional (2D) or three-dimensional (3D) representation of the virtual environment 102 to their respective user. Examples of a virtual environment 102 may include, but are not limited to, a graphical or virtual representation of a metaverse, a map, a building interior, a landscape, a fictional location, an alternate reality, or any other suitable type of location or environment. The virtual environment 102 may be configured to use realistic or non-realistic physics for the motion of objects within the virtual environment 102. For example, some virtual environments 102 may be configured to use gravity whereas other virtual environments 102 may not be configured to use gravity. Within the virtual environment 102, each user may be associated with an avatar (such as the first avatar 114 for the first user 110 and the second avatar 116 for the second user). An avatar is a graphical representation of a user at a virtual location within the virtual environment 102. In embodiments, the virtual location of the avatar may be correlated to the physical location of a user in the real-world environment. Examples of an avatar may include, but are not limited to, a person, an animal, or an object. In some embodiments, the features and characteristics of the avatar may be customizable, and user defined. For example, the size, shape, color, attire, accessories, or any other suitable type of appearance features may be specified by a user. By using an avatar, a user is able to move within the virtual environment 102 to interact with one or more avatars and objects within the virtual environment 102 while independently remaining at a physical location in the real-world environment or being in transit in the real-world environment.

While engaging in the virtual environment 102 via the first avatar 114 and the second avatar 116, the first user 110 (e.g., entity owner) and the second user 112 (e.g., customer) may interact with each user, objects, and/or entities. For example, the second user 112 may attempt to engage in an interaction session with the first avatar 114 through the second avatar 116 associated with the second user 112. In another example, the first avatar 114 of the first user 110 may access a virtual sub-environment (not shown) within the virtual environment 102 and perform virtual data interactions within the virtual sub-environment. In the real-world environment, the second user 112 may be physically located at a distance away from the first user 110. The second user 112 may access the virtual environment 102 through the second user device 106 to control the second avatar 116 and attempt to engage in an interaction session with the first user 110 through the first avatar 114.

Before the interaction between the first avatar 114 and the second avatar 116 occurs, the virtual-world server 150 may authenticate that the first avatar 114 is associated with the first user 110 and not an unauthorized third-party. For example, the first user 110 may be required to sign into a secure portal that provides access to a data file (e.g., real-world data file 138 and/or virtual data file 160) associated with the first user 110. As shown in FIG. 1, a real-world data file 138 of the first user 110 is stored and managed by the real-world server 130 and a virtual data file 160 of the first user 110 is stored and managed by the virtual-world server 150. Similarly, a virtual data file 160 associated with the second user 112 is managed by the virtual-world server 150. It may be noted that the discussion relating to the virtual data file 160 associated with the first user 110 applies to the virtual data file 160 associated with the second user 112. In one or more embodiments, the virtual-world server 150 may employ single sign-on (SSO), multifactor authentication, or any other suitable authentication scheme in order to allow the first user 110 and the second user 112 access to the virtual data file 160. Similarly, the real-world server 130 may employ single sign-on (SSO), multifactor authentication, or any other suitable authentication scheme in order to allow the first user 110 and the second user 112 access to the real-world data file 138. The virtual data file 160 and the real-world data file 138 may include virtual data objects 162 and real-world data objects 140 respectively. In one embodiment, the virtual data objects 162 and the real-world data objects 140 may include products sold by or associated with the first entity 122 and/or the second entity 124. In one embodiment, the first entity 122 and the second entity 124 discussed herein may be merchants selling various objects (e.g., products), the first user 110 may be a merchant owner associated with one or more of these merchants, and the second user 112 may be a user intending to interact with the first user 110 (e.g., entity or merchant owner) in the virtual environment 102 to purchase one or more objects (e.g., products) sold by these merchants. The real-world server 130 and the virtual-world server 150 may store other information related to the first user 110 and the second user 112 including, but not limited to, user information 174 (including user credential 176 and user profile 178), entity information 180 (including entity owner credential 182 and entity owner profile 184), account information (e.g., including identity and other details relating to the respective data files 138 and 160), avatar information, digital assets (e.g., respective real-world data objects 140 and virtual data objects 162) information, or any other suitable type of information that is associated with a user within the virtual environment 102 and/or the real-world environment.

As shown in FIG. 1, virtual-world server 150 comprises a processor 152, a memory 156, and a network interface 154. The processor 152 comprises one or more processors operably coupled to the memory 156. The processor 152 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 152 may be a programmable logic device, a microcontroller, a microprocessor, or any suitable combination of the preceding. The processor 152 is communicatively coupled to and in signal communication with the memory 156. The one or more processors are configured to process data and may be implemented in hardware or software. For example, the processor 152 may be 8-bit, 16-bit, 32-bit, 64-bit or of any other suitable architecture. The processor 152 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

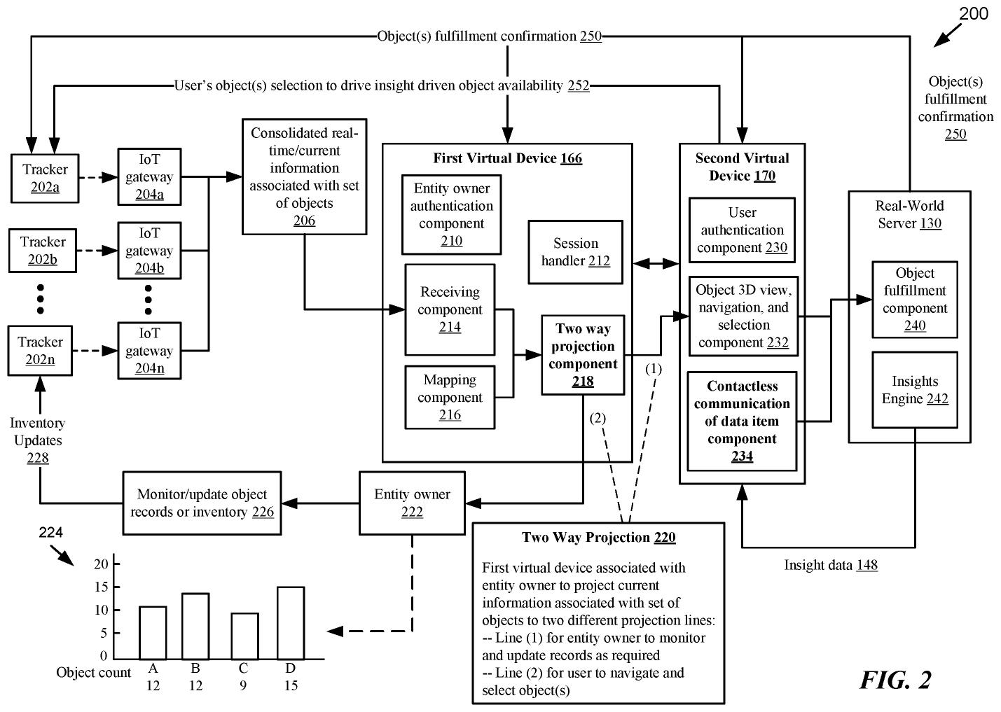

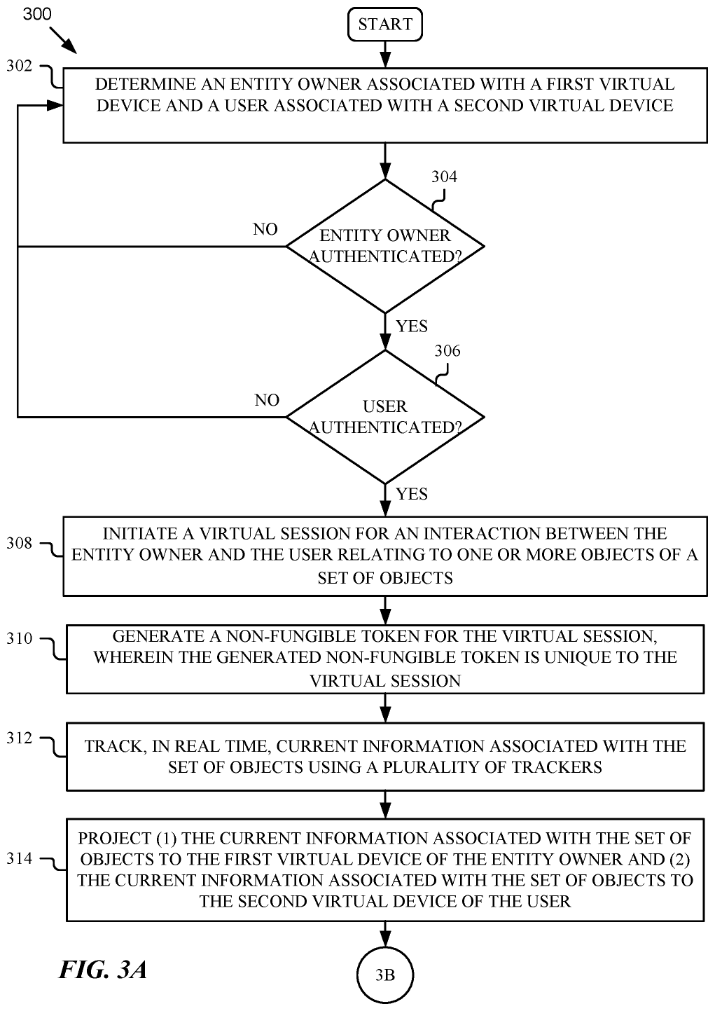

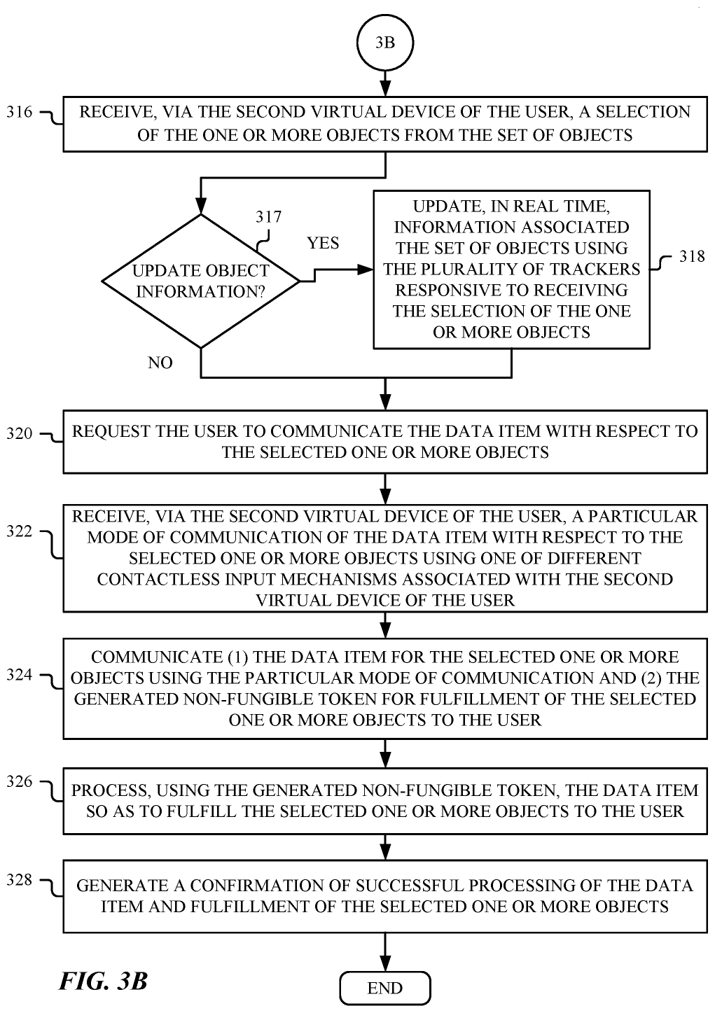

The one or more processors are configured to implement various instructions. For example, the one or more processors are configured to execute instructions (e.g., virtual-world server instructions 164) to implement the virtual-world server 150. In this way, processor 152 may be a special-purpose computer designed to implement the functions disclosed herein. In one or more embodiments, the virtual-world server 150 is implemented using logic units, FPGAs, ASICs, DSPs, or any other suitable hardware. The virtual-world server 150 is configured to operate as described with reference to FIGS. 2 and 3A-3B. For example, the processor 152 may be configured to perform at least a portion of the method 300 as described in FIGS. 3A-3B.

The memory 156 comprises one or more disks, tape drives, or solid-state drives, and may be used as an over-flow data storage device, to store programs when such programs are selected for execution, and to store instructions and data that are read during program execution. The memory 156 may be volatile or non-volatile and may comprise a read-only memory (ROM), random-access memory (RAM), ternary content-addressable memory (TCAM), dynamic random-access memory (DRAM), and static random-access memory (SRAM).

The memory 156 is operable to store virtual data file 160, virtual data objects 162 (e.g., virtual products, virtual payment cards, electronic wallet, etc.), device information 168 associated with the first virtual device 166 (e.g., first user device 104), device information 172 associated with the second virtual device 170 (e.g., second user device 106), user information 174 (including user credential 176 and user profile 178) associated with the second user 112 (e.g., customer), entity information 180 (including entity owner credential 182 and entity owner profile 184) associated with the first user 110 (e.g., entity owner), virtual session information 186 including information relating to virtual session initiated for an interaction between the first user 110 and the second user 112, interaction metadata 188 including metadata relating to the interaction between the first user 110 and the second user 112, and the virtual-world server instructions 164. The virtual-world server instructions 164 may include any suitable set of instructions, logic, rules, or code operable to execute the virtual-world server 150.

The network interface 154 is configured to enable wired and/or wireless communications. The network interface 154 is configured to communicate data between the virtual-world server 150 and other devices, systems, or domains (e.g., user devices 104 and 106, real-world server 130, and token server 190). For example, the network interface 154 may comprise a Wi-Fi interface, a LAN interface, a WAN interface, a modem, a switch, or a router. The processor 152 is configured to send and receive data using the network interface 154. The network interface 154 may be configured to use any suitable type of communication protocol as would be appreciated by one of ordinary skill in the art.

The real-world server 130 comprises a processor 132, a memory 134, and a network interface 136. The processor 132 comprises one or more processors operably coupled to the memory 134. The processor 132 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 132 may be a programmable logic device, a microcontroller, a microprocessor, or any suitable combination of the preceding. The processor 132 is communicatively coupled to and in signal communication with the memory 134. The one or more processors are configured to process data and may be implemented in hardware or software. For example, the processor 132 may be 8-bit, 16-bit, 32-bit, 64-bit or of any other suitable architecture. The processor 132 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute instructions (e.g., real-world server instructions 146) to implement the real-world server 130. In this way, processor 132 may be a special-purpose computer designed to implement the functions disclosed herein. In one or more embodiments, the real-world server 130 is implemented using logic units, FPGAs, ASICs, DSPs, or any other suitable hardware. The real-world server 130 is configured to operate as described with reference to FIGS. 2 and 3A-3B. For example, the processor 132 may be configured to perform at least a portion of the method 300 as described in FIGS. 3A-3B.

The memory 134 comprises one or more disks, tape drives, or solid-state drives, and may be used as an over-flow data storage device, to store programs when such programs are selected for execution, and to store instructions and data that are read during program execution. The memory 134 may be volatile or non-volatile and may comprise a read-only memory (ROM), random-access memory (RAM), ternary content-addressable memory (TCAM), dynamic random-access memory (DRAM), and static random-access memory (SRAM).

The memory 134 is operable to store information relating to real-world data file 138, real-world data objects 140 (e.g., products), insight data 148 representing historical preferences and interactions of a set of users (e.g., first user 110 and/or the second user 112) with respect to a set of objects, the user information 174 associated with the second user 112, the entity information 180 associated with the first user 110, and the real-world server instructions 146. The real-world server instructions 146 may include any suitable set of instructions, logic, rules, or code operable to execute the real-world server 130.

The network interface 136 is configured to enable wired and/or wireless communications. The network interface 136 is configured to communicate data between the real-world server 130 and other devices, systems, or domains (e.g., user devices 104 and 106, virtual-world server 150, and token server 190). For example, the network interface 136 may comprise a Wi-Fi interface, a LAN interface, a WAN interface, a modem, a switch, or a router. The processor 132 is configured to send and receive data using the network interface 136. The network interface 136 may be configured to use any suitable type of communication protocol as would be appreciated by one of ordinary skill in the art.

Each of the real-world server 130 and the virtual-world server 150 is generally a suitable server (e.g., including a physical server and/or virtual server) operable to store data in a memory (e.g., respective memories 134 and 156) and/or provide access to application(s) or other services. One or both of the real-world server 130 and the virtual-world server 150 may be a backend server associated with a particular entity (e.g., organization) that facilitates conducting data interactions between entities, between one or more users, and/or between a user and an entity. In other embodiments, one or both of the real-world server 130 and the virtual-world server 150 may be organized in a distributed manner, or by leveraging cloud computing technologies. Real-world server 130 may store information which is primarily used to support data interactions performed in the real-world environment. Virtual-world server 150 may store information which is primarily used to support data interactions performed in the virtual environment 102 (e.g., a metaverse environment). It may be noted that the operations performed by the real-world server 130 and the virtual-world server 150 described in embodiments of the present disclosure may be implemented by a single server.

The token server 190 comprises a processor 192, a memory 198, and a network interface 196. The processor 192 comprises one or more processors operably coupled to the memory 198. The processor 192 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 192 may be a programmable logic device, a microcontroller, a microprocessor, or any suitable combination of the preceding. The processor 192 is communicatively coupled to and in signal communication with the memory 198. The one or more processors are configured to process data and may be implemented in hardware or software. For example, the processor 192 may be 8-bit, 16-bit, 32-bit, 64-bit or of any other suitable architecture. The processor 192 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute instructions (e.g., token server instructions) to implement the token server 190. As depicted, the processor 192 includes a token generator 194, which may be configured to generate a non-fungible token (NFT) for a virtual session initiated for an interaction between a first user 110 (e.g., entity owner) and a second user 112 (e.g., customer). The generated non-fungible token is unique to the virtual session and may include or be based upon user information 174 associated with the second user 112 (e.g., customer), entity information 180 associated with the first user 110 (e.g., entity owner), virtual session information 186 associated with the virtual session, device information 168 (e.g., unique identifiers) associated with the first virtual device 166, and device information 172 (e.g., unique identifiers) associated with the second virtual device 170. Since the non-fungible token exists only for the virtual session and is no longer available after this session, information associated with the virtual session, such as, for example and without limitation, user information and entity owner information, remain confidential and are secured from various types of attacks present in a virtual or an online environment.

In this way, processor 192 may be a special-purpose computer designed to implement the functions disclosed herein. In one or more embodiments, the token server 190 is implemented using logic units, FPGAs, ASICs, DSPs, or any other suitable hardware. The token server 190 is configured to operate as described with reference to FIGS. 1 and 3A-3B. For example, the processor 192 may be configured to perform at least a portion of the method 300 as described in FIGS. 3A-3B.

The memory 198 comprises one or more disks, tape drives, or solid-state drives, and may be used as an over-flow data storage device, to store programs when such programs are selected for execution, and to store instructions and data that are read during program execution. The memory 198 may be volatile or non-volatile and may comprise a read-only memory (ROM), random-access memory (RAM), ternary content-addressable memory (TCAM), dynamic random-access memory (DRAM), and static random-access memory (SRAM).

The memory 198 is operable to store at least token data 199 relating to a non-fungible token generated by the token generator 194. The token data 199 may include, for example and without limitation, one or more of user information 174 associated with the second user 112 (e.g., customer), entity information 180 associated with the first user 110 (e.g., entity owner), virtual session information 186 associated with the virtual session, device information 168 (e.g., unique identifiers) associated with the first virtual device 166, or device information 172 (e.g., unique identifiers) associated with the second virtual device 170.

The network interface 196 is configured to enable wired and/or wireless communications. The network interface 196 is configured to communicate data between the token server 190 and other devices, systems, or domains (e.g., user devices 104 and 106, real-world server 130, and virtual-world server 150). For example, the network interface 196 may comprise a Wi-Fi interface, a LAN interface, a WAN interface, a modem, a switch, or a router. The processor 192 is configured to send and receive data using the network interface 196. The network interface 196 may be configured to use any suitable type of communication protocol as would be appreciated by one of ordinary skill in the art.

The communication network 195 may facilitate communication within the system 100. This disclosure contemplates the communication network 195 being any suitable network operable to facilitate communication between the first user device 104 (e.g., first virtual device 166), second user device 106 (e.g., second virtual device 170), real-world server 130, virtual-world server 150, and token server 190. Communication network 195 may include any interconnecting system capable of transmitting audio, video, signals, data, messages, or any combination of the preceding. Communication network 195 may include all or a portion of a local area network (LAN), a wide area network (WAN), an overlay network, a software-defined network (SDN), a virtual private network (VPN), a packet data network (e.g., the Internet), a mobile telephone network (e.g., cellular networks, such as 4G or 5G), a Plain Old Telephone (POT) network, a wireless data network (e.g., WiFi, WiGig, WiMax, etc.), a Long Term Evolution (LTE) network, a Universal Mobile Telecommunications System (UMTS) network, a peer-to-peer (P2P) network, a Bluetooth network, a Near Field Communication network, a Zigbee network, and/or any other suitable network, operable to facilitate communication between the components of system 100. In other embodiments, system 100 may not have all of these components and/or may have other elements instead of, or in addition to, those above.

Each of the user devices (i.e., first user device 104 and second user device 106) may be any computing device configured to communicate with other devices, such as a server (e.g., real-world server 130, virtual-world server 150, token server 190), databases, etc. through the communication network 195. Each of the user devices may be configured to perform specific functions described herein and interact with one or more of real-world server 130, the virtual-world server 150, or the token server 190, e.g., via respective user interfaces. Each of the user devices is a hardware device that is generally configured to provide hardware and software resources to a user. Examples of a user device include, but are not limited to, a virtual reality device, an augmented reality device, a mixed reality device, a laptop, a computer, a smartphone, a tablet, a smart device, an Internet-of-Things (IoT) device, or any other suitable type of device. The user devices may comprise a graphical user interface (e.g., a display), a touchscreen, a touchpad, keys, buttons, a mouse, or any other suitable type of hardware that allows a user to view data and/or to provide inputs into the user device. Each user device may be configured to allow a user to send requests to one or both of real-world server 130 and the virtual-world server 150, or to another user device.

### Two-Way Projection of Information and Contactless Communication of a Data Item

FIG. 2 is an example operational flow 200 of the system of FIG. 1. More specifically, the operation flow 200 represents example communications between various devices (e.g., first virtual device 166, second virtual device 170, virtual-world server 150, and real-world server 130) of the system 100 for two-way projection of information and contactless communication of a data item, in accordance with one or more embodiments of the present disclosure. In particular embodiments, the first virtual device 166 associated with an entity owner 222 acts a primary orchestrator to receive consolidated real-time information associated with a set of objects and enable contactless communication of a data item for one or more objects by the second virtual device 170 associated with a user. The various functions discussed here with respect to the first virtual device 166 and the second virtual device 170 may be implemented by or hosted on the virtual-world server 150. For example, the processor 152 of the virtual-world server 150 may perform the various functions of the first virtual device 166 and the second virtual device 170 discussed herein.

The entity owner 222 associated with the first virtual device 166 and the user associated with the second virtual device 170 may interact with each other relating to one or more objects. For example, the user associated with the second virtual device 170 may be interested in procuring the one or objects, which may be managed and/or sold by the entity owner 222 associated with the first virtual device 166. In order to procure the one or more objects, the entity owner 222 associated with the first virtual device 166 and the user associated with the second virtual device 170 may interact with each other. To perform the interaction, the entity owner 222 and the user may need to be first authenticated. This may be done by an entity owner authentication component 210 and a user authentication component 230. For instance, the entity owner authentication component 210 authenticates the entity owner 222 associated with the first virtual device 166 by requesting the entity owner for entity information 180 and authenticating the entity owner based on the entity information 180. Similarly, the user authentication component 230 authenticates the user associated with the second virtual device 170 by requesting the user for user information 174 and authenticating the user based on the user information 174. In one embodiment, authentication may be performed responsive to the two users wearing their respective virtual devices. In another embodiment, the authentication may be performed when one of the users chooses to interact with another user. Once both the users are authenticated, a session handler 212 initiates a virtual session for an interaction between the entity owner 222 associated with the first virtual device 166 and the user associated with the second virtual device 170. The session handler 212 may also communicate with the token server 190 to generate a non-fungible token for the virtual session. The generated non-fungible token is unique to the virtual session and may include the user information associated with the user, the entity information associated with the entity owner, session information associated with the virtual session, and unique identifiers associated with the first and second virtual devices. Since the non-fungible token exists only for the virtual session and is no longer available after this session, information associated with the virtual session, such as, for example and without limitation, user information and entity owner information, remain confidential and are secured from various types of attacks present in a virtual or an online environment. In some embodiments, the session handler 212 may send the generated non-fungible token to the second virtual device 170, which may later use the non-fungible token for object procurement and/or fulfillment, as discussed later below.

A plurality of trackers 202a, 202b, . . . , 202n (individually and/or collectively herein referred to as 202) track current information associated with a set of objects. Each tracker of the trackers 202 may be configured to track current information associated with a subset of objects of a particular type or category. The current information may include, for example and without limitation, available objects of the particular type or category, price per object, which object(s) are added, which object(s) are deleted/removed, etc. Each of the trackers 202a, 202b, . . . , 202n regularly send their tracked real-time or current information associated with their respective objects via predefined Internet-of-Things (IoT) gateways 204a, 204b, . . . , 204n and the individually tracked information by the trackers 202 is combined into a consolidated current information associated with the set of objects, as indicated by reference numeral 206. In one embodiment, the consolidated current information associated with the set of objects 206 is a consolidated real-time inventory snapshot.

The consolidated real-time or current information associated with the set of objects 206 (e.g., real-time inventory snapshot) is received by a receiving component 214 of the first virtual device 166. A mapping component 216 tracks certain object details and maps the details with the objects received in the consolidated information 206. For example, the mapping component 216 tracks current price for each object and maps the current price with that object to reflect current object price. The receiving component 214 and the mapping component 216 may then pass their respective information to a two-way projection component 218, which performs two-way projection 220 of current information associated with the set of objects, as discussed below.

The two-way projection 220 may include simultaneously projecting, using mesh technology, the current information associated with the set of objects to two different projection lines, which includes line 1 for the entity owner 222 associated with the first virtual device 166 to monitor and update object records as required and line 2 for the user associated with the second virtual device 170 to navigate and select one or more objects from the set of objects. Stated differently, the two-way projection component 218 is configured to simultaneously project (1) the current information associated with the set of objects to the first virtual device 166 of the entity owner 222 and (2) the current information associated with the set of objects to the second virtual device 170 of the user. The simultaneous two-way projection 220 of the current or real-time information may help the entity owner 222 associated with an entity to keep their records associated with the objects up to date. In addition, using mesh technology, this two-way projection 220 of real-time information may help the entity owner 222 to see what particular objects the user is interacting with and may further enable the entity owner 222 to reach out to the user as needed to help drive their object selection. Furthermore, the simultaneous two-way projection 220 of real-time information ensures that the entity owner and the user are always viewing current available objects and associated information. This enables the entity owner to keep an accurate count of the objects and the user to not select objects that are not available (e.g., because these objects have been previously selected by another user).

In one embodiment, the current information associated with the set of objects that is projected to the first virtual device 166 of the entity owner 222 may include a count information indicating a total number of objects currently available for each type of the set of objects, as indicated by reference numeral 224. The entity owner 222 may use the count information (e.g., as indicated by reference numeral 224) to monitor and/or update object records or inventory, as indicated by reference numeral 226. The updated object records and/or inventory updates 228 may be sent to the plurality of trackers 202, which may then update the information associated with the set of objects accordingly. For example, the inventory updates 228 from the entity owner 222 may instruct the trackers 202 to remove one or more objects from the set of objects.

In one embodiment, the current information associated with the set of objects that is projected to the second virtual device 170 of the user may include a three-dimensional (3D) view (e.g., a 360-degree view) of each object of the set of objects. The 3D view may be displayed by an object 3D view, navigation, and selection component 232 of the second virtual device 170 associated with the user. In some embodiments, the second virtual device 170 may receive insight data 148 from an insights engine 242 of the real-world server 130. The insight data 148 may represent historical preferences and interactions of a set of users including the user with respect to the set of objects. Based on the insight data 148, the object 3D view, navigation, and selection component 232 may suggest a subset of objects from the set of objects or additional objects relating to the set of objects for display on the second virtual device of the user.

From the set of objects, subset of objects, and/or the additional objects relating to the set of objects displayed to the user on the second virtual device 170, the user may navigate and select one or more objects. Once the user selects one or more objects, the information associated with the set of objects may be updated in real-time to reflect the current information. For instance, as indicated by reference numeral 252 in FIG. 2, user's object(s) selection is sent to the trackers 202 to drive insight driven object availability. Based on the object(s) selection information received from the second virtual device 170, the plurality of trackers 202 may update information associated with the set of objects. For example, the one or more objects that are selected by the user may be removed from the set of objects known by the plurality of trackers 202. This would avoid another user selecting the same one or more objects that have already been selected by the user associated with the second virtual device 170. The updated information may then be projected to the first virtual device 166 of the entity owner 222 and/or the second virtual device 170 of the user. The updated information may be used by the entity owner 222 to further monitor and/or update the object records. Also, the updated information may be used by the user to navigate and select a subsequent set of objects.

Once the user selects the one or more objects, the user's object(s) selection may be passed to the contactless communication of a data item component 234, which may then request the user to communicate a data item with respect to the selected one or more objects. For example, responsive to user selecting the one or more objects, the contactless communication of a data item component 234 may request the user to provide a payment for the selected objects. Based on the request, the contactless communication of a data item component 234 may receive, via the second virtual device 170 of the user, a particular mode of communication of the data item with respect to the selected one or more objects. In one embodiment, the particular mode of the communication of the data item is a particular payment method by which the user would like to pay for the selected one or more objects (e.g., products) for procurement. The particular mode of the communication of the data item may be received using one or more of different contactless input mechanisms associated with the second virtual device 170 of the user. The different contactless input mechanisms may include, for example and without limitation, an eye gesture, a voice command, or haptic feedback.

By way of an example, after selecting the one or more objects from the set of objects presented to the user, the user may select and provide a payment for the selected one or more objects simply by an eye gesture (e.g., user blinking their eyes), a voice command, or some sort of haptic feedback. This way the user may view, navigate, select, and/or procure the one or more objects and perform an interaction with the entity owner in a virtual environment without requiring an explicit contact by the user.

Responsive to receiving the particular mode of the communication of the data item from the user, the contactless communication of data item component 234 or the first virtual device 166 may communicate or send (1) the data item for the selected one or more objects using the particular mode of communication of the data item and (2) the generated non-fungible token (e.g., received from the session handler 212) for fulfillment of the selected one or more objects to the user. As discussed elsewhere herein, the data item for the selected one or more objects may be communicated without requiring explicit contact by the user. For example, the user may communicate the data item (e.g., payment) for the selected objects simply by blinking their eyes. The data item for the selected one or more objects and the generated non-fungible token may be received by an object fulfillment component 240 of the real-world server 130 (e.g., application server or a bank server). The object fulfillment component 240 may process, using the generated non-fungible token, the data item so as to fulfill the selected one or more objects to the user. Since all the relevant user information (e.g., user identifier, payment details, address, contact information, identifier of the second virtual device 170 associated with the user, etc.) and the entity owner's information (e.g., entity owner's identifier, entity details, address, contact information, identifier of the first virtual device 166 associated with the entity owner, etc.) already included in the non-fungible token, the object fulfillment component 240 may verify the data item (e.g., payment) received from the second virtual device 170 of the user with the information included in the non-fungible token to fulfill the selected objects to the user. This would save time for the user to quickly procure the selected objects without requiring explicit contact or input by the user (e.g., providing user's and entity owner's information, payment details, etc.). In some embodiments, the object fulfillment component 240 may verify and/or process the data item via one or more back-end servers. For example, the object fulfillment component 240 may provide the data item and the non-fungible token that it has received to the one or more back-end servers, which may then perform a lookup of information relevant for fulfillment of the selected object(s) using the information included in the non-fungible token and process (e.g., approve/decline) the data item.

Responsive to successfully processing the data item, the object fulfillment component 240 may generate object(s) fulfillment confirmation 250 indicative of successful processing of the data item and fulfillment of the selected one or more objects to the user. The real-world server 130 may send the object(s) fulfillment confirmation 250 to one or more of the first virtual device 166 associated with the entity owner 222, the second virtual device 170 associated with the user, or the plurality of trackers 202. Using the object(s) fulfillment confirmation 250, the plurality of trackers 202 may update the information associated with the set of objects. For example, the trackers 202 may deduct the one or more objects that have been fulfilled to the user from the set of objects. The updated information may be sent to the first virtual device 166 of the entity owner to update the records associated with the set of objects, as discussed elsewhere herein.

In an example e-commerce and banking use case, the system and method disclosed in accordance with embodiments of the present disclosure may allow a merchant or a merchant owner (e.g., first user 110) and a customer (e.g., second user 112) to remotely interact with each other using their smart glass devices (e.g., first virtual device 166 and second virtual device 170) and further enable the customers to make contactless payments for product(s) sold by the merchant. In this context, the real-world server 130 may be owned and/or operated by a bank. The virtual-world server 150 may be operated by the same bank or may be operated by another entity. The set of objects discussed herein may correspond to products sold by the merchant or the merchant owner. The first virtual device 166 and the second virtual device 170 may correspond to wearable artificial reality devices, such as smart glass devices (e.g., AR glasses). Using the smart glass devices, the merchant owner and the user may interact with each other. The interaction between the merchant owner and the customer may correspond to a financial transaction by the customer for one or more products to obtain from the merchant owner. The plurality of trackers 202 may correspond to inventory trackers configured to track current product inventory and pricing information (e.g., product availability, price per product, which products are added, which products are deducted, etc.). The consolidated real-time or current information associated with the set of objects (e.g., as indicated by reference numeral 206) may correspond to a consolidated real time product inventory snapshot that is sent to the smart glass of the merchant. The smart glass of the merchant may perform the two-way projection 220, which includes projecting the latest product data to two different projection lines: line 1 for merchant to monitor and update records as required and line 2 for customers to navigate and select products. Using mesh technology, same 3D view of products may be displayed simultaneously to both the merchant as well as the customer. The customer selects one or more products from the 3D view of products and provides a data item with respect to these selected products. The data item may correspond to a payment provided by the customer for the one or more products selected by the customer for purchase. The contactless communication of the data item may correspond to making contactless payment for the product(s) selected by the customer. The particular mode of communication of the data item may correspond to a particular payment mode or method (e.g., electronic wallet, payment card, etc.) chosen by the customer for making contactless payment to the merchant owner for the product(s) selected by the customer. The customer may select particular payment mode and make contactless payment via gestures, such as, for example, by blinking their eyes.

### Example Method

FIGS. 3A-3B illustrate a flowchart of an example method 300 for two-way projection of information and contactless communication of a data item, in accordance with one or more embodiments of the present disclosure. Modifications, additions, or omissions may be made to method 300. Method 300 may include more, fewer, or other steps. For example, operations may be performed in parallel or in any suitable order. While at times discussed as the system 100, virtual-world server 150, processor 152, real-world server 130, token server 190, or components of any of thereof performing steps, any suitable system or components of the system may perform one or more steps of the method 300. For example, one or more steps of method 300 may be implemented, at least in part, in the form of software instructions (e.g., software instructions 164 of FIG. 1), stored on non-transitory, tangible, machine-readable media (e.g., memory 156 of FIG. 1) that when run by one or more processors (e.g., processor 152 of FIG. 1) may cause the one or more processors to perform steps 302-328. Stated differently, method 300 may be performed by the virtual-world server 150 shown in FIG. 1.

At operation 302, virtual-world server 150 may determine an entity owner associated with a first virtual device (e.g., first virtual device 166) and a user associated with a second virtual device (e.g., second virtual device 170). The first and second virtual devices may be wearable artificial reality devices. In one embodiment, determining the entity owner associated with the first virtual device and the user associated with the second virtual device may include requesting the entity owner for entity information (e.g., entity information 180) to authenticate the entity owner, requesting the user for user information (e.g., user information 174) to authenticate the user, and authenticating the entity owner and the user based on the entity information and the user information, respectively.

At operation 304, virtual-world server 150 may make a determination of whether the entity owner is successfully authenticated. If the result is negative, method 300 returns back to operation 302 to re-determine the entity owner. If the result of the determination in operation 304 is positive, the method 300 proceeds to operation 306, where the virtual-world server 150 may make a determination of whether the user associated with the second virtual device is successfully authenticated. If the result is negative, method 300 returns back to operation 302 to re-determine the user associated with the second virtual device. If the result of the determination in operation 306 is positive, the method 300 proceeds to operation 308, where the virtual-world server 150 may initiate a virtual session for an interaction between the entity owner and the user relating to one or more objects of a set of objects. The entity owner and the user may interact with each other during the virtual session using the first and second virtual devices.

At operation 310, virtual-world server 150, in communication with token server 190, may generate a non-fungible token for the virtual session. The generated non-fungible token is unique to the virtual session. In one embodiment, the generated non-fungible token may include the user information associated with the user, the entity information associated with the entity owner, session information associated with the virtual session, and unique identifiers associated with the first and second virtual devices.

At operation 312, virtual-world server 150 may track, in real time, current information associated with the set of objects using a plurality of trackers (e.g., trackers 202). Each tracker may be configured to track a subset of objects of a particular type. The current information may include, for example and without limitation, available objects of the particular type or category, price per object, which object(s) are added, which object(s) are deleted/removed, etc.

At operation 314, virtual-world server 150 may project (1) the current information associated with the set of objects to the first virtual device of the entity owner and (2) the current information associated with the set of objects to the second virtual device of the user. The current information associated with the set of objects is simultaneously projected to the first virtual device of the entity owner and the second virtual device of the user using mesh technology. The current information associated with the set of objects that is projected to the first virtual device of the entity owner may be configured to be used by the entity owner to monitor and update records associated with the set of objects. In one embodiment, the current information associated with the set of objects that is projected to the first virtual device of the entity owner may include count information indicating a total number of objects currently available for each type of the set of objects. The current information associated with the set of objects that is projected to the second virtual device of the user may be configured to be used by the user to navigate and select the one or objects from the set of objects. In one embodiment, the current information associated with the set of objects that is projected to the second virtual device of the user may include 3D view of each object of the set of objects.

In some embodiments, virtual-world server 150 may receive insight data (e.g., insight data 148) from real-world server 130. The insight data may include or represent historical preferences and interactions of a set of users including the user with respect to the set of objects. Based on the insight data, virtual-world server 150 may suggest a subset of objects from the set of objects or additional objects relating to the set of objects for display on the second virtual device of the user.

Referring now to FIG. 3B, responsive to the two-way projection of the current information, at operation 316, virtual-world server 150 may receive, via the second virtual device of the user, a selection of the one or more objects from the set of objects. At operation 317, virtual-world server 150 may make a determination of whether to update object information. If the result of the determination is positive, at operation 318, virtual-world server 150 may update, in real time, information associated with the set of objects using the plurality of trackers responsive to receiving the selection of the one or more objects from the user associated with the second virtual device. In one embodiment, updating the information may include removing the selected one or more objects from the set of objects stored in a memory (e.g., memory 156). Updated information may be projected to one or more of the first virtual device of the entity owner or the second virtual device of the user. The updated information may be used by the entity owner to update the records associated with the set of objects and the updated information may be used by the user to navigate and select a subsequent set of objects.

If the result of the determination of operation 317 is negative, the method 300 proceeds to operation 320, where virtual-world server 150 may request the user to communicate the data item with respect to the selected one or more objects. At operation 322, virtual-world server 320 may receive, via the second virtual device of the user, a particular mode of communication of the data item with respect to the selected one or more objects using one or more of different contactless input mechanisms associated with the second virtual device of the user. The different contactless input mechanisms associated with the second virtual device of the user may include, for example and without limitation, an eye gesture, a voice command, or haptic feedback.

At operation 324, virtual-world server 150 may communicate (1) the data item for the selected one or more objects using the particular mode of communication of the data item and (2) the generated non-fungible token for fulfillment of the selected one or more objects to the user. The data item may be communicated for the selected one or more objects without requiring explicit contact by the user. At operation 326, virtual-world server 150, in communication with real-world server 130, may process the data item using the generated non-fungible token so as to fulfill the selected one or more objects to the user.

At operation 328, virtual-world server 150, in communication with real-world server 130, may generate a confirmation (e.g., object(s) fulfillment confirmation 250) of successful processing of the data item and fulfillment of the selected one or more objects. The confirmation may be sent to one or more of the first virtual device of the entity owner, the second virtual device of the user, or the plurality of trackers. The plurality of trackers may update information associated with the set of objects responsive to the fulfillment of the selected one or more objects. Updated information may be sent to the first virtual device of the entity owner to update the records associated with the set of objects.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. A system for two-way projection of information and contactless communication of a data item, the system comprising:
a memory operable to store a set of objects, user information associated with a user, and entity information associated with an entity owner; and
a processor, operably coupled with the memory, and configured to:
determine the entity owner associated with a first virtual device and the user associated with a second virtual device;
initiate a virtual session for an interaction between the entity owner and the user relating to one or more objects of the set of objects, wherein the entity owner and the user interact with each other during the virtual session using the first and second virtual devices;
generate a non-fungible token for the virtual session, wherein the generated non-fungible token is unique to the virtual session, and wherein the generated non-fungible token comprises the user information associated with the user, the entity information associated with the entity owner, session information associated with the virtual session, and unique identifiers associated with the first and second virtual devices;
track, in real time, current information associated with the set of objects using a plurality of trackers, wherein each tracker is configured to track a subset of objects of a particular type;
project (1) the current information associated with the set of objects to the first virtual device of the entity owner and (2) the current information associated with the set of objects to the second virtual device of the user, wherein the current information associated with the set of objects that is projected to the first virtual device of the entity owner is configured to be used by the entity owner to monitor and update records associated with the set of objects, and wherein the current information associated with the set of objects that is projected to the second virtual device of the user is configured to be used by the user to navigate and select the one or objects from the set of objects;
receive, via the second virtual device of the user, a selection of the one or more objects from the set of objects;
request the user to communicate the data item with respect to the selected one or more objects;
receive, via the second virtual device of the user, a particular mode of communication of the data item with respect to the selected one or more objects using one or more of different contactless input mechanisms associated with the second virtual device of the user;
communicate (1) the data item for the selected one or more objects using the particular mode of communication of the data item and (2) the generated non-fungible token for fulfillment of the selected one or more objects to the user, wherein the data item is communicated for the selected one or more objects without requiring explicit contact by the user;
process, using the generated non-fungible token, the data item so as to fulfill the selected one or more objects to the user; and
generate a confirmation of successful processing of the data item and fulfillment of the selected one or more objects, wherein the confirmation is sent to one or more of the first virtual device of the entity owner, the second virtual device of the user, or the plurality of trackers.

2. The system of claim 1, wherein the processor is further configured to:
responsive to the fulfillment of the selected one or more objects, update information associated with the set of objects using the plurality of trackers;
wherein updated information is sent to the first virtual device of the entity owner to update the records associated with the set of objects.

3. The system of claim 1, wherein the current information associated with the set of objects is simultaneously projected to the first virtual device of the entity owner and the second virtual device of the user using mesh technology.

4. The system of claim 1, wherein:
the current information associated with the set of objects that is projected to the first virtual device of the entity owner comprises a count information indicating a total number of objects currently available for each type of the set of objects; and
the current information associated with the set of objects that is projected to the second virtual device of the user comprises a three-dimensional (3D) view of each object of the set of objects.

5. The system of claim 1, wherein determining the entity owner associated with the first virtual device and the user associated with the second virtual device comprises:
requesting the entity owner for the entity information to authenticate the entity owner;
requesting the user for the user information to authenticate the user; and
authenticating the entity owner and the user based on the entity information and the user information, respectively.

6. The system of claim 1, wherein the first virtual device or the second virtual device is a wearable artificial reality device.

7. The system of claim 1, wherein the processor is further configured to:
responsive to receiving the selection of the one or more objects from the set of objects, update, in real time, information associated with the set of objects using the plurality of trackers; and
project updated information associated with the set of objects to one or more of the first virtual device of the entity owner or the second virtual device of the user;
wherein the updated information is used by the entity owner to update the records associated with the set of objects, and wherein the updated information is used by the user to navigate and select a subsequent set of objects.

8. The system of claim 7, wherein updating the information associated with the set of objects comprises:
removing the selected one or more objects from the set of objects stored in the memory.

9. The system of claim 1, wherein the processor is further configured to:
receive insight data representing historical preferences and interactions of a set of users including the user with respect to the set of objects; and
suggest a subset of objects from the set of objects or additional objects relating to the set of objects for display on the second virtual device of the user based on the insight data.

10. The system of claim 1, wherein the different contactless input mechanisms associated with the second virtual device of the user comprise:
an eye gesture;
a voice command; or
haptic feedback.

11. A method for two-way projection of information and contactless communication of a data item, the method comprising:
determining an entity owner associated with a first virtual device and a user associated with a second virtual device;
initiating a virtual session for an interaction between the entity owner and the user relating to one or more objects of a set of objects, wherein the entity owner and the user interact with each other during the virtual session using the first and second virtual devices;
generating a non-fungible token for the virtual session, wherein the generated non-fungible token is unique to the virtual session, and wherein the generated non-fungible token comprises user information associated with the user, entity information associated with the entity owner, session information associated with the virtual session, and unique identifiers associated with the first and second virtual devices;
tracking, in real time, current information associated with the set of objects using a plurality of trackers, wherein each tracker is configured to track a subset of objects of a particular type;
projecting (1) the current information associated with the set of objects to the first virtual device of the entity owner and (2) the current information associated with the set of objects to the second virtual device of the user, wherein the current information associated with the set of objects that is projected to the first virtual device of the entity owner is configured to be used by the entity owner to monitor and update records associated with the set of objects, and wherein the current information associated with the set of objects that is projected to the second virtual device of the user is configured to be used by the user to navigate and select the one or objects from 20 the set of objects;
receiving, via the second virtual device of the user, a selection of the one or more objects from the set of objects;
requesting the user to communicate the data item with respect to the selected one or more objects;
receiving, via the second virtual device of the user, a particular mode of communication of the data item with respect to the selected one or more objects using one or more of different contactless input mechanisms associated with the second virtual device of the user;
communicating (1) the data item for the selected one or more objects using the particular mode of communication of the data item and (2) the generated non-fungible token for fulfillment of the selected one or more objects to the user, wherein the data item is communicated for the selected one or more objects without requiring explicit contact by the user;
processing, using the generated non-fungible token, the data item so as to fulfill the selected one or more objects to the user; and
generating a confirmation of successful processing of the data item and fulfillment of the selected one or more objects, wherein the confirmation is sent to one or more of the first virtual device of the entity owner, the second virtual device of the user, or the plurality of trackers.

12. The method of claim 11, further comprising:
responsive to the fulfillment of the selected one or more objects, updating information associated with the set of objects using the plurality of trackers;
wherein updated information is sent to the first virtual device of the entity owner to update the records associated with the set of objects.

13. The method of claim 11, wherein the current information associated with the set of objects is simultaneously projected to the first virtual device of the entity owner and the second virtual device of the user using mesh technology.

14. The method of claim 11, wherein:
the current information associated with the set of objects that is projected to the first virtual device of the entity owner comprises a count information indicating a total number of objects currently available for each type of the set of objects; and
the current information associated with the set of objects that is projected to the second virtual device of the user comprises a three-dimensional (3D) view of each object of the set of objects.

15. The method of claim 11, wherein determining the entity owner associated with the first virtual device and the user associated with the second virtual device comprises:
requesting the entity owner for the entity information to authenticate the entity owner;
requesting the user for the user information to authenticate the user; and
authenticating the entity owner and the user based on the entity information and the user information, respectively.

16. A non-transitory computer-readable medium storing instructions that when executed by a processor cause the processor to:
determine an entity owner associated with a first virtual device and a user associated with a second virtual device;
initiate a virtual session for an interaction between the entity owner and the user relating to one or more objects of a set of objects, wherein the entity owner and the user interact with each other during the virtual session using the first and second virtual devices;
generate a non-fungible token for the virtual session, wherein the generated non-fungible token is unique to the virtual session, and wherein the generated non-fungible token comprises user information associated with the user, entity information associated with the entity owner, session information associated with the virtual session, and unique identifiers associated with the first and second virtual devices;
track, in real time, current information associated with the set of objects using a plurality of trackers, wherein each tracker is configured to track a subset of objects of a particular type;
project (1) the current information associated with the set of objects to the first virtual device of the entity owner and (2) the current information associated with the set of objects to the second virtual device of the user, wherein the current information associated with the set of objects that is projected to the first virtual device of the entity owner is configured to be used by the entity owner to monitor and update records associated with the set of objects, and wherein the current information associated with the set of objects that is projected to the second virtual device of the user is configured to be used by the user to navigate and select the one or objects from the set of objects;
receive, via the second virtual device of the user, a selection of the one or more objects from the set of objects;
request the user to communicate a data item with respect to the selected one or more objects;
receive, via the second virtual device of the user, a particular mode of communication of the data item with respect to the selected one or more objects using one or more of different contactless input mechanisms associated with the second virtual device of the user;
communicate (1) the data item for the selected one or more objects using the particular mode of communication of the data item and (2) the generated non-fungible token for fulfillment of the selected one or more objects to the user, wherein the data item is communicated for the selected one or more objects without requiring explicit contact by the user;
process, using the generated non-fungible token, the data item so as to fulfill the selected one or more objects to the user; and
generate a confirmation of successful processing of the data item and fulfillment of the selected one or more objects, wherein the confirmation is sent to one or more of the first virtual device of the entity owner, the second virtual device of the user, or the plurality of trackers.

17. The non-transitory computer-readable medium of claim 16, wherein the instructions further cause the processor to:
responsive to the fulfillment of the selected one or more objects, update information associated with the set of objects using the plurality of trackers;
wherein updated information is sent to the first virtual device of the entity owner to update the records associated with the set of objects.

18. The non-transitory computer-readable medium of claim 16, wherein the current information associated with the set of objects is simultaneously projected to the first virtual device of the entity owner and the second virtual device of the user using mesh technology.

19. The non-transitory computer-readable medium of claim 16, wherein:
the current information associated with the set of objects that is projected to the first virtual device of the entity owner comprises a count information indicating a total number of objects currently available for each type of the set of objects; and
the current information associated with the set of objects that is projected to the second virtual device of the user comprises a three-dimensional (3D) view of each object of the set of objects.

20. The non-transitory computer-readable medium of claim 16, wherein determining the entity owner associated with the first virtual device and the user associated with the second virtual device comprises:
requesting the entity owner for the entity information to authenticate the entity owner;
requesting the user for the user information to authenticate the user; and
authenticating the entity owner and the user based on the entity information and the user information, respectively.
